(19) United States
(12) Patent Application Publication
(10) Pub. No.: US 2023/0369768 A1
(43) Pub. Date: Nov. 16, 2023

(54) ULTRA-WIDEBAND ANTENNA ASSEMBLY

(71) Applicant: KYOCERA AVX Components (San Diego), Inc., San Diego, CA (US)

(72) Inventors: Olivier Pajona, Biot (FR); Florian Canneva, Cannes (FR); Thomas Fontanille, Biot (FR)

(21) Appl. No.: 18/307,919

(22) Filed: Apr. 27, 2023

Related U.S. Application Data
(60) Provisional application No. 63/336,442, filed on Apr. 29, 2022.

(51) Int. Cl. H01Q 9/30; H01Q 1/36; H01Q 1/48; H01Q 21/06

(52) U.S. Cl. CPC H01Q 9/30; H01Q 1/36; H01Q 1/48; H01Q 21/06

(57) ABSTRACT

Example antenna assemblies are provided. In one example implementation, the antenna assembly includes a substrate having a first surface and an opposing second surface. The antenna assembly includes a ground plane. The antenna assembly includes a curved conical portion and a top portion. The top portion includes an undulating annular ring disposed on the curved conical portion.

### PRIORITY CLAIM

The present application is based on and claims priority to U.S. Provisional Application No. 63/336,442, titled “UWB Antenna,” having a filing date of Apr. 29, 2022, which is incorporated by reference herein.

### FIELD

The present disclosure relates generally to an antenna assembly, and more particularly to an ultra-wideband antenna assembly configured to provide more uniform gain and uniform phase in multiple directions across a large bandwidth of frequencies, such as from about 3 GHz to about 10 GHz.

### BACKGROUND

Antennas can be used to facilitate wireless communication between devices. It can be desirable for antennas to operate across a wide range of frequencies, such as in the superhigh frequency band, such as from about 3 GHz to about 10 GHz. Frequencies in the superhigh frequency band can span the S-band, C-band, and X-band. Antennas operable in these frequency bands can be used for a variety of applications, including satellite communications, radar, weather radar, navigational assistance, vessel identification and tracking, air traffic control, inflight Wifi, spacecraft telemetry and other applications.

### SUMMARY

Aspects and advantages of embodiments of the present disclosure will be set forth in part in the following description, or may be learned from the description, or may be learned through practice of the embodiments.

One example embodiment of the present disclosure is directed to an antenna assembly. The antenna assembly includes a substrate having a first surface and an opposing second surface. The antenna assembly includes a ground plane. The antenna assembly includes a curved conical portion and a top portion. The top portion includes an undulating annular ring disposed on the curved conical portion.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a perspective view of an antenna assembly according to example embodiments of the present disclosure;

FIG. 2 depicts a side view of an antenna assembly according to example embodiments of the present disclosure;

FIG. 3 depicts a top view of an antenna assembly according to example aspects of the present disclosure;

FIG. 4 depicts an electronic device having an antenna assembly according to example embodiments of the present disclosure;

FIG. 5 depicts an antenna assembly including an array of antenna elements according to example embodiments of the present disclosure;

FIG. 6 depicts an antenna assembly including an array of antenna elements according to example embodiments of the present disclosure;

FIG. 7 depicts S11 parameters for an example antenna assembly according to example aspect of the present disclosure;

FIG. 8 depicts efficiency for an example antenna assembly according to example aspect of the present disclosure;

FIGS. 9A, 9B, and 9C depict an example radiation pattern for an example antenna assembly according to example aspect of the present disclosure;

FIGS. 10A, 10B, and 10C depict an example radiation pattern for an example antenna assembly according to example aspect of the present disclosure; and

FIGS. 11A, 11B, and 11C depict an example radiation pattern for an example antenna assembly according to example aspect of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to an antenna assembly. In some antenna applications, such as applications where determining angle of arrival or time of flight is important, it can be useful to have an antenna or an antenna element of an antenna array that can provide uniform gain and uniform phase in all or nearly all directions across a wide range of frequencies, such as frequencies in a range from about 3 GHz to about 10 GHz.

For instance, in one example, it can be useful to provide an ultra-wideband antenna array with antenna elements that have more uniform phase and more uniform gain in all or nearly all directions to determine angle of arrival over short distances, such as less than 100 meters, such as less than 50 meters. In some implementations, it can be useful to provide an ultra-wideband antenna array with antenna elements that have more uniform phase and gain in all or nearly all directions to determine angle of arrival over short distances, such as less than 100 meters, such as less than 50 meters.

According to example aspects of the present disclosure, an antenna assembly can include a substrate (e.g., a circuit board) having a first surface and an opposing second surface. The antenna assembly can include a ground plane. The antenna assembly can include an antenna having a curved conical portion and a top portion. The top portion can include an undulating annular ring disposed on the base portion. In some embodiments, the top portion can be integral with the base portion.

In some embodiments, the antenna can include a base portion. The curved conical portion can extend from the base portion. The base portion can be integral with the curved conical portion or can be a separate structure coupled to the curved conical portion. The base portion can be used to affix the antenna to the substrate. A feed for the antenna can be coupled directly to the curved conical portion and/or to the base portion.

In some embodiments, the undulating annular ring can include a plurality of curved peaks and a plurality of curved valleys. A height of the curved peaks can be greater than a height of the curved valleys. In some embodiments, the undulating annular ring can include three curved peaks and three curved valleys. In some embodiments, the plurality of curved peaks can occur at regular intervals about the annular ring. In some embodiments, the undulating annular ring comprises a sinusoid structure.

In some embodiments, a combined height of the curved conical structure and the top portion can be in a range from about 1 mm to about 10 mm. In some embodiments, a diameter of the undulating annular ring can be in a range from about 8.5 mm to about 12.5 mm. As used herein, the use of the term “about” in conjunction with a numerical value refers to a value that falls within 15% of the stated numerical value.

In some embodiments, the substrate (e.g., the circuit board) can have a first surface and an opposing second surface. The ground plane can be disposed on the first surface. The antenna can extend from the second surface in a direction generally perpendicular to the second surface. As used herein, the term “generally perpendicular” refers to within 15 degrees of perpendicular.

In some embodiments, the antenna can be configured to provide an S11 parameter of about −3 dB or less at frequencies in a range from about 5 GHz to about 14.5 GHz. In some embodiments, the antenna can be configured to provide an omnidirectional radiation pattern at frequencies in a range from about 3 GHz to about 10 GHz. As used herein the term “omnidirectional radiation pattern” indicates a radiation pattern having a uniform gain (e.g., gain within 5% of a specified gain magnitude) for at least 345 degrees about an antenna in at least one plane. In some embodiments, the antenna can be configured to provide an efficiency of −5 dB or greater at frequencies in a range from about 6 GHz to about 10 GHz.

Another example aspect of the present disclosure can include an antenna array comprising a plurality of antenna elements (e.g., at least two antenna elements, such as at least three antenna elements). Each antenna element can include, for instance, a curved conical portion and a top portion. The top portion can be integral with the curved conical portion. The top portion can include an undulating sinusoid annular ring. In some embodiments, each antenna element can include one or more aspects of any of the antennas described in this disclosure.

In some embodiments, the antenna array can include antenna elements extending in different directions. For instance, the antenna array can include a first antenna element extending in a first direction. The antenna array can include a second antenna element extending in a second direction. The antenna array can include a third antenna element extending in a third direction. Each of the first direction, second direction, and third direction can be different directions. In some embodiments, each of the first direction, second direction, and third direction can be generally perpendicular to one another.

Another example aspect of the present disclosure is directed to an electronic device that includes an antenna assembly according to example aspects of the present disclosure. The antenna assembly can include one or more aspects of any of the antenna assemblies described herein. In some embodiments, the antenna assembly can be an antenna array. The electronic device can be used for a variety of purposes and applications without deviating from the scope of the present disclosure. The antenna assembly can be used to facilitate wireless communications of the electronic device with one or more remote devices over various frequency bands, such as a frequency band including frequencies in a range of about 3 GHz to about 10 GHz.

The antenna assembly(s) according to example aspects of the present disclosure can provide numerous technical effects and benefits. For instance, the antenna assembly according to example aspects of the present disclosure can provide increased uniformity in gain and phase over an omnidirectional radiation pattern over a wide range of frequencies, such as frequencies in a range between about 3 GHz to about 10 GHz.

In one example, the antenna assembly can be used for angle of arrival and/or time of flight applications in short distance applications, such as for distances of less than about 100 meters, such as less than about 75 meters, such as less than about 50 meters, such as less than about 25 meters. For instance, an antenna assembly can include a plurality of antenna elements according to example aspects of the present disclosure. Each of the antenna elements can have uniform gain and/or phase in an omnidirectional pattern. Signals incident on the different antenna elements can be processed to determine time of flight and/or angle of arrival, for instance, by processing timing and phase information for a receive signal on the different antenna elements (e.g., measuring a difference in received time or received phase at each antenna element). The difference in received phase can be used to determine the angle of arrival the receive signal at the array. The difference in received time can be used to determine time of flight of the receive signal at the array. Providing antenna elements with omnidirectional uniformity in phase and in gain can improve the accuracy of angle of arrival determinations and time of flight determinations.

Determining angle of arrival and time of flight over short distances can be particularly useful. For instance, in keyless entry applications, angle of arrival and/or time of flight determinations can be used to determine whether signals are being received by a legitimate entry device or if they are coming from a security compromised device (e.g., a device that is not located where it should be located). This can be particularly useful, for instance, in preventing unauthorized or capturing of information for keyless entries by devices that are not located proximate to equipment (e.g., automotive vehicle) or premises (e.g., a building).

With reference now to the FIGS., example embodiments of the present disclosure will now be set forth.

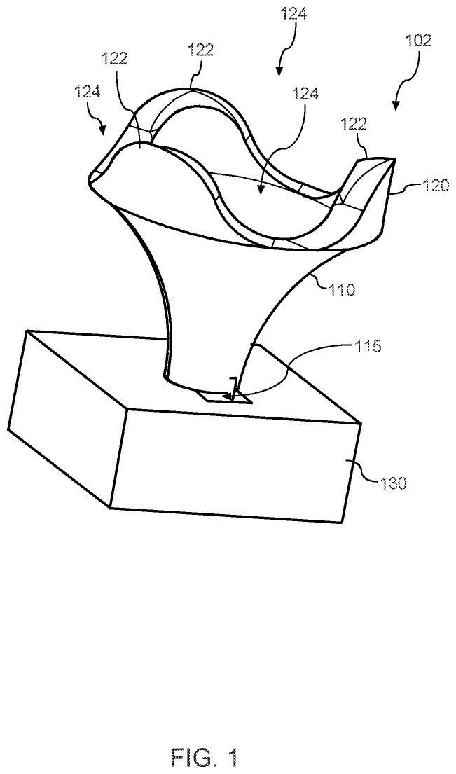

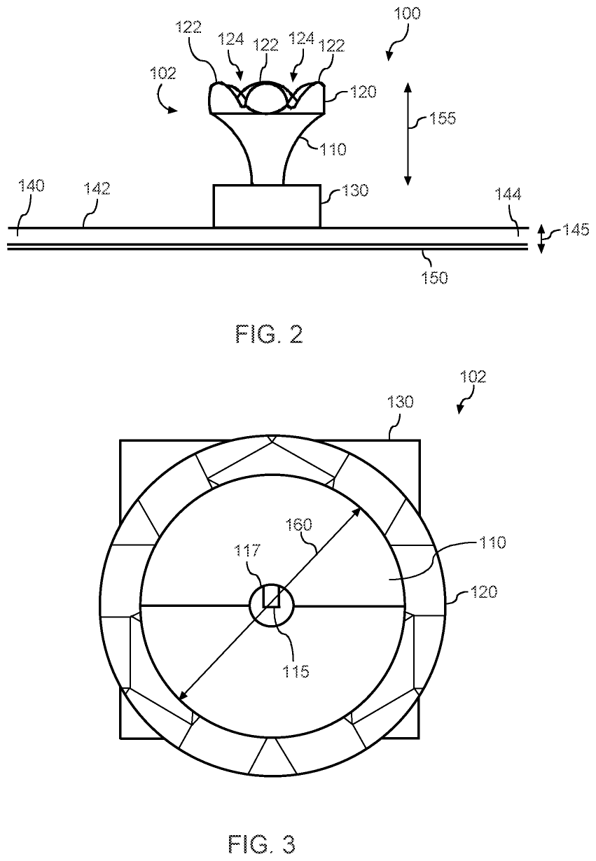

FIGS. 1-3 depicts an example antenna assembly 100 according to example embodiments of the present disclosure. The antenna assembly 100 includes an antenna 102 having a curved conical portion 110 and a top portion 120. As shown particularly in FIG. 2, the antenna assembly 100 can include a substrate 140 (e.g., a circuit board). The antenna 102 can extend in a generally perpendicular direction from the substrate 140. The substrate 140 can have a first surface 142 and an opposing second surface 144 separated by a thickness 145. The substrate 140 can be made of any suitable material, such as any suitable dielectric material. The substrate 140 can include various elements other than the antenna 102, such as one or more traces, surface mount devices, transmission lines, antenna feeds, or other elements.

The antenna 102 includes a curved conical portion 110. The curved conical portion 110 can include curved edges. As shown in FIG. 3, a portion of the curved conical portion 110 can be removed at a first end of the curved conical structure 110 to provide an opening 117. The first end of the curved conical structure 110 can extend from a base portion 130. A second end of the curved conical portion 110 can be coupled to top portion 120 such that the curved conical portion 110 extends between the base portion 130 and the top portion 120.

The top portion 120 can be an undulating annular ring. The undulating annular ring can be a sinusoid structure. For instance, the undulating ring can have a shape that if extended in a straight line resembles a sinusoid (e.g., a curve having the form of a sine wave). In some embodiments, the undulating annular ring can have a plurality of curved peaks 122 and a plurality of curved valleys 124, such as three curved peaks 122 and three curved valleys 124. The height of the curved peaks 122 can be greater than a height of the curved valleys 124. While the annular ring of FIGS. 1-3 has three curved peaks 122 and three curved valleys 124, the annular ring can include more or fewer curved peaks and curved valleys without deviating from the scope of the present disclosure. In some embodiments, the curved peaks 122 and the curved valleys 124 can occur at regular intervals about the annular ring.

In some embodiments, a combined height 155 of the curved conical portion 110 and the top portion 120 is in a range from about 1 mm to about 10 mm. In some embodiments, a diameter 160 of the undulating annular ring is in a range from about 8.5 mm to about 12.5 mm.

In some embodiments, the curved conical portion 110 and the top portion 120 can be formed entirely out of a conductive material, such as a metal. In some embodiments, the curved conical portion 110 and the top portion 120 can be formed as metal surfaces on a dielectric material (e.g., using laser direct sintering techniques). For instance, in one example implementation, the curved conical portion 110 and the top portion 120 can include a dielectric material. A metal layer can be formed on one or more surfaces of the dielectric material, such as only on an outer surface of the dielectric material (and not on the inner surface of the dielectric material).

The base portion 130 can be a rectangular structure, such as a three-dimensional rectangular structure where at least one surface is a rectangle (e.g., a square). The base portion 130 can be used affix or mount the antenna 102 to the substrate 140. In some embodiments, an antenna feed 115 can be coupled to the base portion 130 and/or the curved conical portion 110 of the antenna 102. The base portion 130 can be conductive structure or a non-conductive structure (e.g., used only to provide support for the antenna 102). In some embodiments, the antenna 102 may not include a base portion 130 and may only include a conical portion 110 and a top portion 120.

As shown in FIG. 2, the substrate 140 (e.g., circuit board) can have a first surface 142 and a second surface 144 separated by a thickness 145 of the substrate 140. A ground plane 150 (e.g., a conductive ground plane) can be disposed on the second surface 144 of the substrate 140. The antenna 102 can extend in a generally perpendicular direction from the first surface 142 of the substrate 140. The ground plane 150 can have an area that is substantially greater than an area associated with a footprint of the antenna 102 on the substrate 140. For instance, the ground plane 150 can have an area that is at least three times greater than an area associated with a footprint of the antenna 102 on the substrate 140, such as five times greater, such as ten times greater, such as twenty times greater, or more.

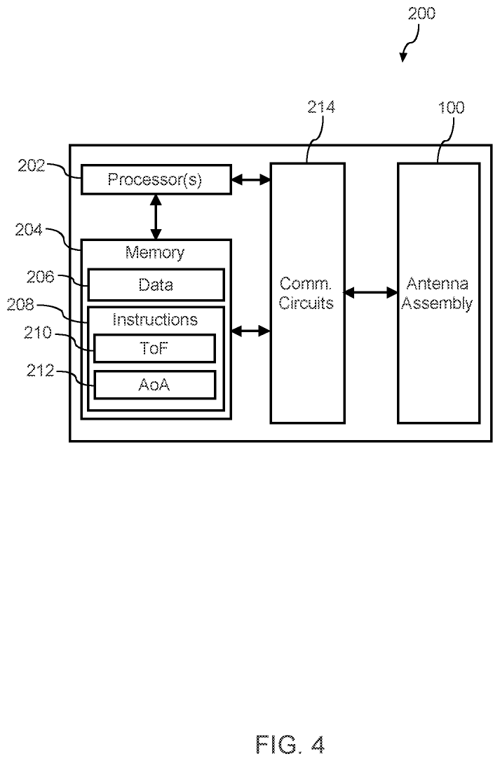

FIG. 4 depicts an example electronic device 200 according to example embodiments of the present disclosure. The electronic device 200 can be any suitable electronic device configured to have wireless communication with one or more remote devices. For instance, the electronic device can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. Those of ordinary skill in the art, using the disclosures provided herein, will understand that any of the antenna assemblies described herein can be used for a variety of applications and devices without deviating from the scope of the present disclosure.

As shown in FIG. 4, the electronic device 200 includes the antenna assembly 100. The antenna assembly 100 can have one or more aspects of any of the antenna assemblies described herein, such as the antenna assemblies described with reference to FIGS. 1-3, 5, 6 or any other portion of this disclosure.

The electronic device 200 can include one or more processors 202 and one or more memory devices 204. The one or more processors 202 can be any suitable processing device, including, but not limited to, one or more microprocessors, microcontrollers, integrated circuits, logic devices or other suitable processing device(s). The one or more memory devices 204 can be any suitable memory device, including, but not limited to, non-transitory computer-readable media, RAM, ROM, hard drives, flash drives, or other memory devices. The one or more memory devices 204 can store data 206 and computer-readable instructions 208. The computer-readable instructions 206 when executed by the one or more processors 202 can the cause the one or more processors 202 to perform operations. The computer-readable instructions 206 can be implemented as software, hardware, and/or a combination of software and hardware. When implemented as software, the computer-readable instructions 206 can be in any suitable language.

The electronic device 200 can include one or more communication circuit(s) 214 to facilitate communication of information by the antenna assembly 100. The communication circuit(s) can include one or more receivers, transmitters, transceivers, front end modules, base band circuits, matching circuits, tuning circuits, control circuits, transmission lines, or other elements to facilitate communication of radiofrequency signals by the antenna assembly, such as radiofrequency signals in frequency bands associated with frequencies in a range from about 3 GHz to about 10 GHz.

As illustrated, the instructions 206 can include, for instance, time of flight instructions 210 and angle of arrival instructions 212. Time of flight instructions 210 can be used to determine time of flight information associated with signals received by antenna assembly 100. For instance, difference in timing of receipt of signals received by one or more antennas or antenna elements in the antenna assembly 100 can be processed using time of flight instructions 210 to determine time of flight information. Difference in phase of signals received by one or more antenna or antenna elements in the antenna assembly 100 can be processed using angle of arrival instructions 212 to determine angle of arrival information.

The antenna assembly 100 according to example aspects of the present disclosure can provide more uniform gain and phase in an omnidirectional pattern in a range of frequencies from about 3 GHz to about 10 GHz. In that regard, the antenna assembly 100 according to example aspects of the present disclosure can be suitable, for instance, for angle of arrival and/or time of flight determinations over short distances, such as less than 100 m, such as less than 50 m.

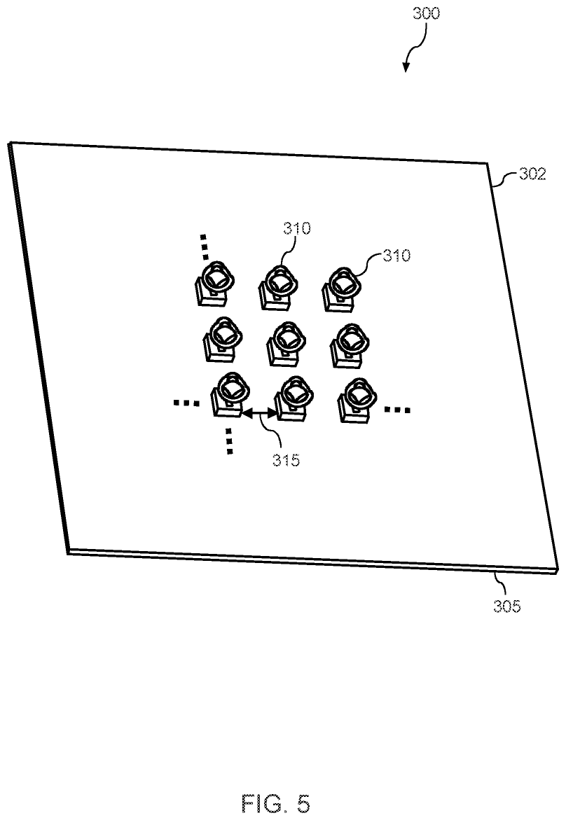

FIG. 5 depict an antenna assembly 300 that include an antenna array. The antenna array can have a plurality of antenna elements 310 (e.g., at least three antenna elements 310) disposed on a substrate 302. Each of the antenna elements 310 can have a configuration of the antenna 102 described with reference to FIG. 1. Each of the antenna elements 310 can extend (e.g., in a generally perpendicular direction) from a first surface of the substrate 302. In the example of FIG. 5, all the antenna elements 310 extend in a same direction from the substrate 302. A spacing 315 between each of the antenna elements can be in a range of about 1 mm to about 6 mm.

A ground plane 305 can be disposed on an opposing second surface of the substrate 302. The ground plane 305 can have an area that is at least three times greater than an area associated with a footprint of each antenna element 310 on the substrate 302, such as five times greater, such as ten times greater, such as twenty times greater, or more.

FIG. 5 depicts an antenna assembly 300 having nine antenna elements 310 arranged in a grid pattern with equal spacing 315 between all antenna elements 310. More or fewer antenna elements 310 can be used without deviating from the scope of the present disclosure, as indicated by the ellipses in FIG. 5 extending in different directions. In some embodiments, the antenna elements 310 can be arranged in a different pattern with regular or irregular spacing. For instance, the antenna elements 310 can be arranged in a circular pattern, geometric pattern, or irregular random pattern.

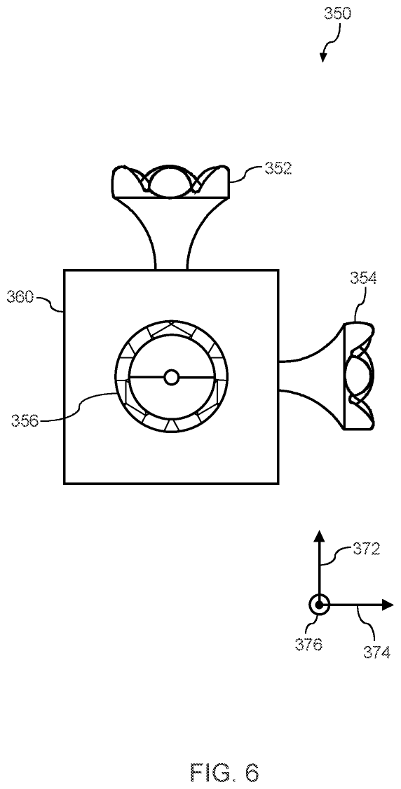

FIG. 6 depicts an example antenna assembly 350 having an antenna array according to example embodiments of the present disclosure. The antenna array can have a plurality of elements 352, 354, 356 extending from a support structure 360 (e.g., structure with multiple support surfaces, a substrate, etc.). Each of the antenna elements 352, 354, 356 can have a configuration of the antenna 102 described with reference to FIG. 1. In the example of FIG. 6, each of the antenna elements 352, 354, 356 can extend in different directions. For instance, a first antenna element 352 can extend in a first direction 372 from the support structure 360. A second antenna element 354 can extend in a second direction 374 from the support structure 360. A third antenna element 356 can extend in a third direction 376 from the support structure.

In the example of FIG. 6, each of the first direction 372, the second direction 374, and the third direction 376 are generally perpendicular to one another. However, any suitable direction or combination of directions and angles relative to directions can be used without deviating from the scope of the present disclosure. In addition, more or fewer antenna elements can be included in the antenna array of the antenna assembly 350 without deviating from the scope of the present disclosure.

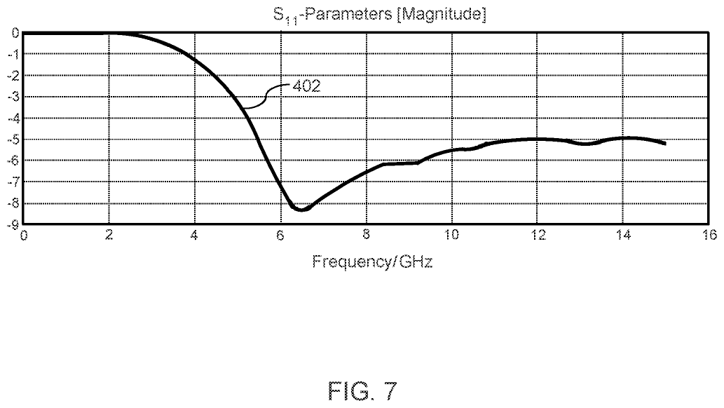

FIG. 7 depicts a plot 402 of an S11 parameter associated with antenna (e.g., antenna 102 of FIG. 1) according to example embodiments of the present disclosure. FIG. 7 plots frequency in GHz along the x-axis and magnitude of S11 parameter (e.g., return loss) in dB along the y-axis. As shown, an antenna assembly according to example embodiments of the present disclosure can provide an S11 parameter of about −3 dB or less at frequencies in a range from about 5 GHz to about 14.5 GHz.

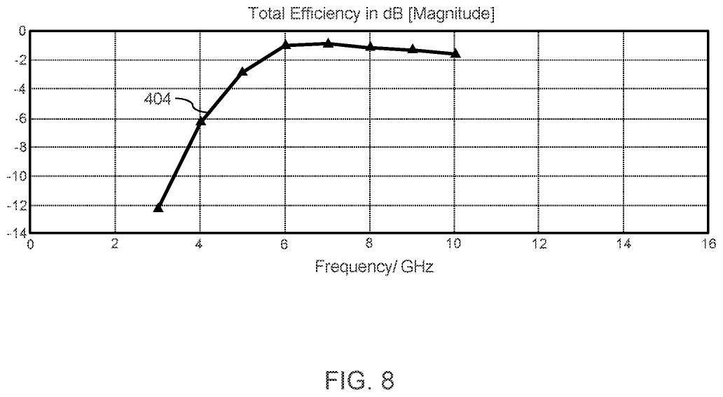

FIG. 8 depicts a plot 404 of antenna efficiency associated with antenna (e.g., antenna 102 of FIG. 1) according to example embodiments of the present disclosure. FIG. 8 plots in GHz along the x-axis and antenna efficiency in dB along the y-axis. As shown, an antenna assembly according to example embodiments of the present disclosure can provide an antenna efficiency of −4 dB or greater at frequencies in a range of about 5 GHz to about 10 GHz.

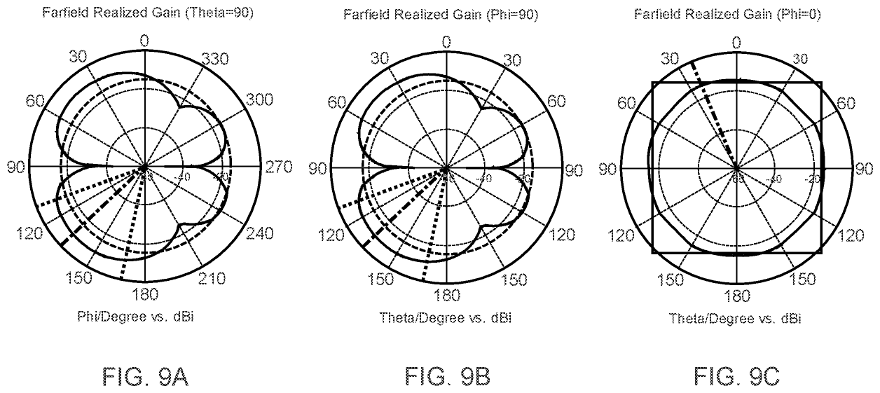

FIGS. 9A, 9B, and 9C depict an antenna radiation pattern associated with a farfield realized gain of about −8 dB for an antenna (e.g., antenna 102 of FIG. 1) at 3 GHz according to example embodiments of the present disclosure. FIG. 9A depicts Phi/Degree v. dBi for Theta=90° plane. FIG. 9B depicts Theta/Degree v. dBi for the Phi=90° plane. FIG. 9C depicts Theta/Degree v. dBi for the Phi=0° plane.

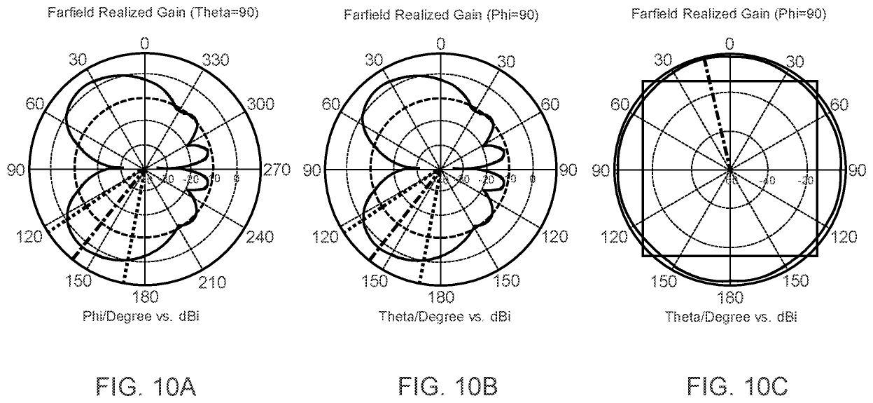

FIGS. 10A, 10B, and 10C depict an antenna radiation pattern associated with a farfield realized gain of about 3.6 dB for an antenna (e.g., antenna 102 of FIG. 1) at 6 GHz according to example embodiments of the present disclosure. FIG. 10A depicts Phi/Degree v. dBi for Theta=90° plane. FIG. 10B depicts Theta/Degree v. dBi for the Phi=90° plane. FIG. 10C depicts Theta/Degree v. dBi for the Phi=0° plane.

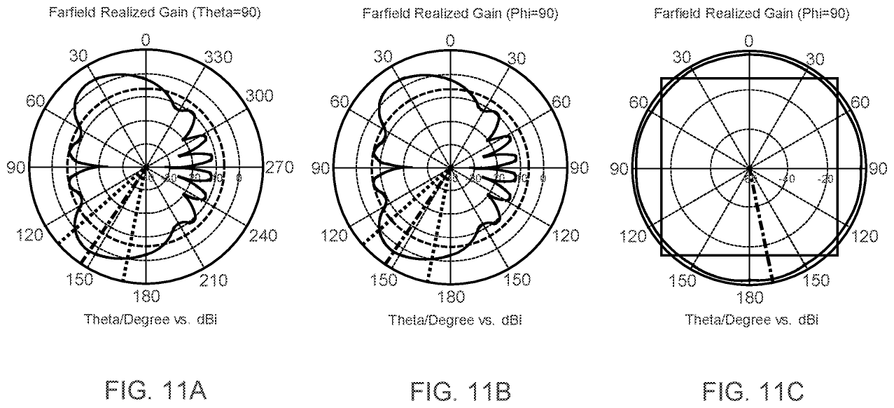

FIGS. 11A, 11B, and 11C depict an antenna radiation pattern associated with a farfield realized gain of about 3.6 dB for an antenna (e.g., antenna 102 of FIG. 1) at 10 GHz according to example embodiments of the present disclosure. FIG. 11A depicts Phi/Degree v. dBi for Theta=90° plane. FIG. 11B depicts Theta/Degree v. dBi for the Phi=90° plane. FIG. 11C depicts Theta/Degree v. dBi for the Phi=0° plane.

As demonstrated by the radiation patterns of FIGS. 9A, 9B, 9C, 10A, 10B, 10C, 11A, 11B, and 11V, an antenna assembly according to example embodiments of the present disclosure can provide an omnidirectional radiation pattern in at least one plane at frequencies in a range of about 3 GHz to about 10 GHz. An omnidirectional radiation pattern refers to a radiation pattern that provides uniform gain (e.g., gain that remains within 5% of a specified value) for 345° about the antenna in at least one plane.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna assembly, comprising:
a substrate having a first surface and an opposing second surface;
a ground plane;
an antenna comprising a curved conical portion and a top portion, the top portion comprising an undulating annular ring disposed on the curved conical portion.

2. The antenna assembly of claim 1, wherein the undulating annular ring comprises a plurality of curved peaks and a plurality of curved valleys, wherein a height of the curved peaks is greater than a height of the curved valleys.

3. The antenna assembly of claim 1, wherein the antenna further comprising a base portion, the curved conical portion extending from the base portion, the base portion comprising a rectangular structure.

4. The antenna assembly of claim 2, wherein the plurality of curved peaks occur at regular intervals about the annular ring.

5. The antenna assembly of claim 1, wherein the undulating annular ring comprises a sinusoid structure.

6. The antenna assembly of claim 1, wherein a combined height of the curved conical portion and the top portion is in a range from about 1 mm to about 10 mm.

7. The antenna assembly of claim 1, wherein the substrate has a first surface and an opposing second surface, wherein the ground plane is disposed on the first surface, wherein the antenna extends from the second surface in a direction generally perpendicular to the second surface.

8. The antenna assembly of claim 1, wherein a diameter of the undulating annular ring is in a range from about 8.5 mm to about 12.5 mm.

9. The antenna assembly of claim 1, wherein the curved conical portion and top portion are integral.

10. The antenna assembly of claim 1, wherein the antenna is configured to provide has an S11 parameter of about −3 dB or less at frequencies in a range from about 5 GHz to about 14.5 GHz.

11. The antenna assembly of claim 1, wherein the antenna is configured to provide an omnidirectional radiation pattern at frequencies in a range from about 3 GHz to about 10 GHz.

12. The antenna assembly of claim 1, wherein the antenna is configured to provide an efficiency of −4 dB or greater at frequencies in a range from about 5 GHz to about 10 GHz.

13. The antenna assembly of claim 1, wherein an antenna feed is coupled to the curved conical portion of the antenna.

14. An antenna array comprising a plurality of antenna elements, each antenna element comprising:
a curved conical portion;
a top portion that is integral with the curved conical portion, the top portion comprising an undulating sinusoid annular ring.

15. The antenna array of claim 14, wherein the sinusoid annular ring comprises three curved peaks and three curved valleys.

16. The antenna array of claim 14, wherein each antenna element has a height in a range of about 1 mm to about 10 mm and a diameter of the undulating sinusoid annular ring is in a range from about 8.5 mm to about 12.5 mm.

17. The antenna array of claim 14, wherein the antenna array comprises at least three antenna elements, each antenna element extending in a different direction.

18. An electronic device, comprising:
a communication circuit;
an antenna assembly, the antenna assembly comprising:
a circuit board having a first surface and an opposing second surface;
a ground plane;
an antenna having a curved conical portion and a top portion, the top portion comprising an undulating annular ring disposed on the curved conical portion.

19. The electronic device of claim 18, wherein the circuit board has a first surface and an opposing second surface, wherein the ground plane is disposed on the first surface, wherein the antenna extends in a direction generally perpendicular to the second surface.

20. The electronic device of claim 18, wherein the undulating annular ring comprises a sinusoid structure.
